(19) United States
(12) Patent Application Publication
(10) Pub. No.: US 2016/0279816 A1
(43) Pub. Date: Sep. 29, 2016

(54) SHAVING RAZOR CARTRIDGE

(71) Applicant: The Gillette Company, Boston, MA (US)

(72) Inventors: Michael Hal Bruno, Burlington, MA (US); Jack Anthony Washington, Quincy, MA (US)

(21) Appl. No.: 15/079,451

(22) Filed: Mar. 24, 2016

(30) Foreign Application Priority Data
Mar. 25, 2015 (EP) 15160873.4

(51) Int. Cl. B26B 21/40; B26B 21/44

(52) U.S. Cl. CPC B26B 21/4018; B26B 21/443

(57) ABSTRACT

A shaving razor cartridge with a housing having a guard at a front portion of the housing, a cap at a rear portion of the housing, a first blade support member positioned between the guard and the cap. The first blade support member has a first blade retention member spaced apart from a second blade retention member to define a first blade slot. The first blade support defines at least one rinse opening in communication with the first blade slot and extending completely through the housing.

### FIELD OF THE INVENTION

The present invention relates to wet shaving safety razors and more particularly to shaving cartridges that have a housing for retaining and/or rigidly fixing one or more blades.

### BACKGROUND OF THE INVENTION

In general, a cartridge or blade unit of a safety razor has at least one blade with a cutting edge which is moved across the surface of the skin being shaved by means of a handle to which the cartridge is attached. Some shaving razors are provided with a spring biased cartridge that pivots relative to the handle to follow the contours of the skin during shaving. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled. Razor cartridges usually include a guard which contacts the skin in front of the blade(s) and a cap for contacting the skin behind the blade(s) during shaving. The cap and guard may aid in establishing the so-called “shaving geometry”, i.e., the parameters which determine the blade orientation and position relative to the skin during shaving, which in turn have a strong influence on the shaving performance and efficacy of the razor. The cap may comprise a water leachable shaving aid to reduce drag and improve comfort. The guard may be generally rigid, for example formed integrally with a frame or platform structure which provides a support for the blades. Guards may also comprise softer elastomeric materials to improve skin stretching.

Wet shaving razors have evolved over the years to include multiple blades that are spaced closer together. The increased number of blades and decreased spacing often creates clogging issues. For example, shaving debris becomes difficult to rinse from the shaving razor cartridge housing. Excessive shaving debris can negatively impact shaving performance, such as shaving efficiency (i.e., missed hairs) and closeness. Thus, there is a need for a safety shaving razor cartridge having a housing to retain the blades in place during a shaving stroke, while also improving the removal of shaving debris (i.e., rinsibility).

### SUMMARY OF THE INVENTION

In one aspect, the invention features, in general a shaving razor cartridge with a housing having a guard at a front portion of the housing, a cap at a rear portion of the housing and a first blade support member positioned between the guard and the cap. The first blade support member has a first blade retention member spaced apart from a second blade retention member to define a first blade slot. The first blade support defines at least one rinse opening in communication with the first blade slot and extending completely through the housing.

### BRIEF DESCRIPTION OF THE DRAWINGS

Other features and advantages of the present invention, as well as the invention itself, can be more fully understood from the following description of the various embodiments, when read together with the accompanying drawings, in which:

FIG. 1 is a perspective view of a shaving razor cartridge according to one possible embodiment of the present invention.

FIG. 2 is a cross section view of the shaving razor cartridge, taken generally along the line 2-2 of FIG. 1

FIG. 3 is an assembly view of the shaving razor cartridge of FIG. 1

FIG. 3A is a perspective view of the housing of FIG. 3.

FIG. 4 is a top view of a housing, which may be incorporated into the shaving razor cartridge of FIG. 1.

FIG. 4A is an enlarged top view of a left hand side of the housing of FIG. 4.

FIG. 4B is an enlarged top view of a right hand side of the housing of FIG. 4.

FIG. 5 is a cross section view of the shaving razor cartridge, taken generally along the line 5-5 of FIG. 1

FIG. 5A is an enlarged view of the left hand side of the shaving razor cartridge of FIG. 5.

FIG. 5B is an enlarged view of the right hand side of the shaving razor cartridge of FIG. 5.

FIG. 6 is an enlarged view of the left hand side of the shaving razor cartridge of FIG. 5 with four blades removed.

### DETAILED DESCRIPTION OF THE INVENTION

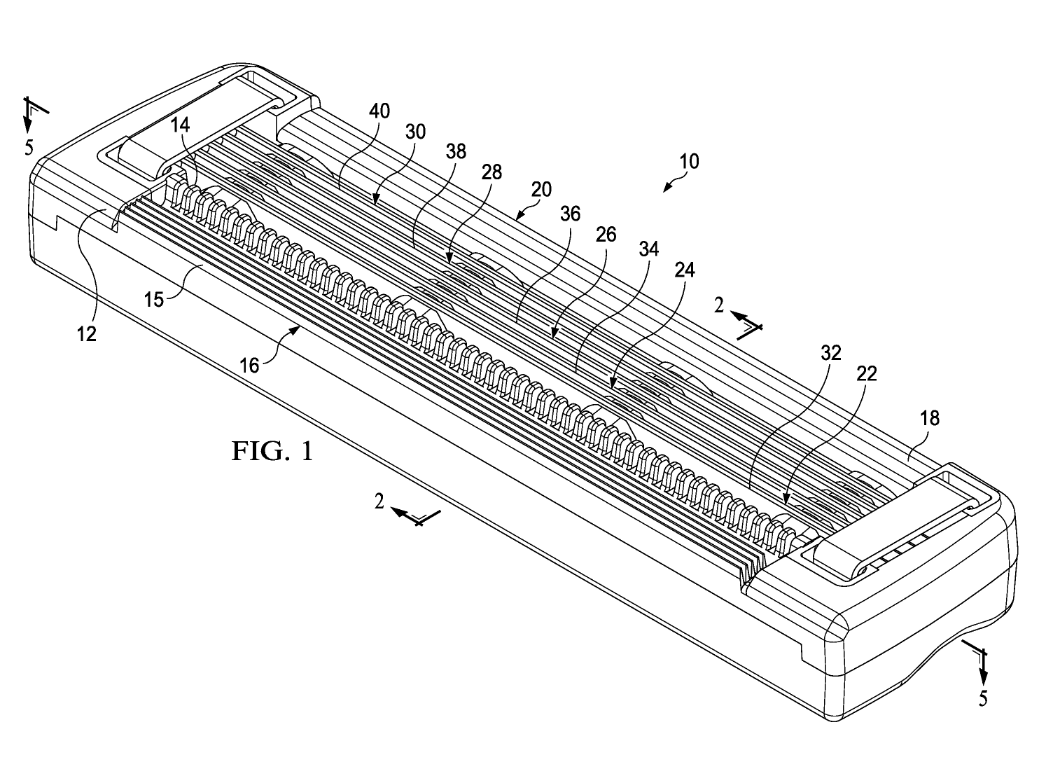

Referring to FIG. 1, a perspective view of a shaving razor cartridge 10 is shown. The shaving razor cartridge 10 may be mounted to handle (not shown). The shaving razor cartridge 10 may be removable or permanently mounted to the handle. For example, the shaving razor cartridge 10 may be mounted detachably on a handle to enable the shaving razor cartridge 10 to be replaced by a fresh shaving razor cartridge 10 when the blade sharpness has diminished to an unsatisfactory level, or it may be attached permanently to the handle with the intention that the entire razor be discarded when the blade or blades have become dulled. The shaving razor cartridge may include a housing 12. The housing 12 may be molded out of a rigid plastic or manufactured from other materials, such as metal. A guard 14 may be positioned at a front portion 16 of the housing and a cap 18 may be positioned at a rear portion 20 of the housing 12. The guard 14 is typically a unitary molded member that can be formed of a rigid plastic (e.g., the same material as the housing 10). In certain embodiments, the cap 18 may comprise one or more lubricants that are released during a shaving stroke.

One or more blades 22, 24, 26, 28 and 30 may be mounted to the housing 12 between the cap 18 and the guard 14 (i.e., in front of the cap 18 and behind the guard 14). The blades 22, 24, 26, 28, and 30 may each have a respective cutting edge 32, 34, 36, 38, and 40 generally directed towards the guard 14. A primary blade 22 may be nearest the guard 14, secondary blade 24 is next nearest the guard 14, and so on until the fifth blade 30 is furthest from the guard 14. Although five blades 22, 24, 26, 28 and 30 are shown, the housing 12 may have more or fewer blades depending on the desired performance and cost of the shaving razor cartridge 10. The guard 14 and the cap 18 may define a shaving plane that is tangent to the guard 14 and the cap 18. The guard 14 may be a solid or segmented bar that extends generally parallel to the blades 22, 24, 26, 28 and 30 and supports the skin during a shaving stroke. In certain embodiments, the housing 12 may comprise a skin-engaging member 15 (e.g., a plurality of fins or other protrusions) in front of the guard 14 for stretching the skin during a shaving stroke. In certain embodiments, the skin-engaging member 15 may be insert injection molded or co-injection molded to the housing 12. However, other known assembly methods may also be used such as adhesives, ultrasonic welding, or mechanical fasteners. The skin engaging member 15 may be molded from a softer material (i.e., lower durometer hardness) than the housing 12, such as an elastomer.

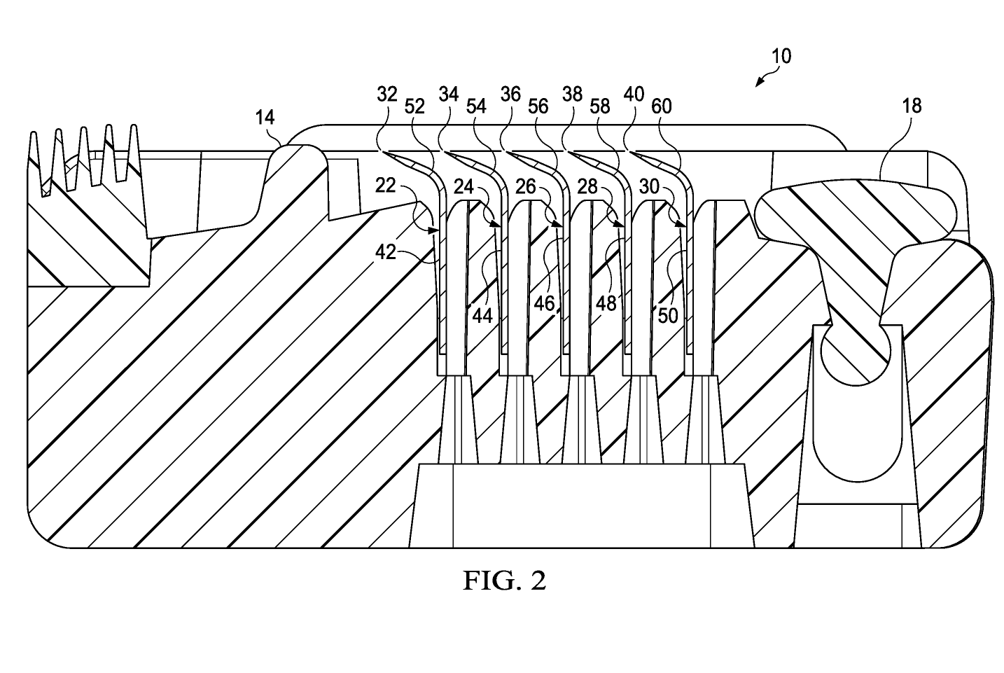

Referring to FIG. 2, a cross section of the shaving cartridge 10 is shown, taken generally along the line 2-2 of FIG. 1. One or more of the blades 22, 24, 26, 28 and 30 may be a bent blade unit. For example, each blade 22, 24, 26, 28 and 30 may comprise a unitary member having a base portion 42, 44, 46, 48 and 50 and respective bent portion 52, 54, 56, 58 and 60 located between the respective cutting edge 32, 34, 36, 38, 40 and the base portion 42, 44, 46, 48 and 50. The base portions 42, 44, 46, 48 and 50 may be generally parallel to each other and transverse to a shaving plane P1 that is tangent to the guard 14 and the cap 18. In other embodiments, the one or more of the blades may be welded blade assemblies (e.g., a blade welded having a cutting edge connected to a blade support having a base portion and a bent portion). FIG. 2 illustrates shaving forces Fl may exert a force on the blades 22, 24, 26, 28 and 30 in a direction from the guard 14 toward the cap 18. Accordingly, the blades 22, 24, 26, 28 and 30 may rock backwards toward the cap 18 during a shaving stroke. The movement of the blades 22, 24, 26, 28 and 30 may increase as the thickness and rigidity of the blades 22, 24, 26, 28 and 30 decreases. The blades 22, 24, 26, 28 and 30 may have a support height “SH1” of about 1.5 mm to about 2.5 mm. For example, the height of the portion of the blade, such as the base 42, that is supported and or contacted by the housing 12.

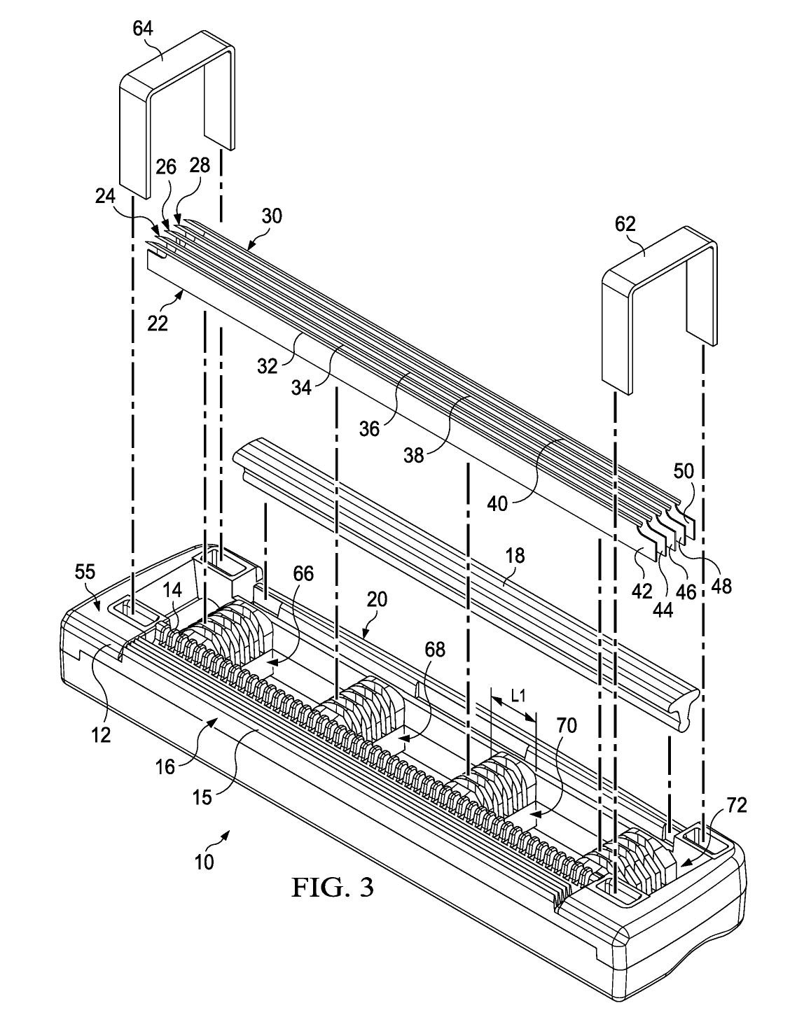

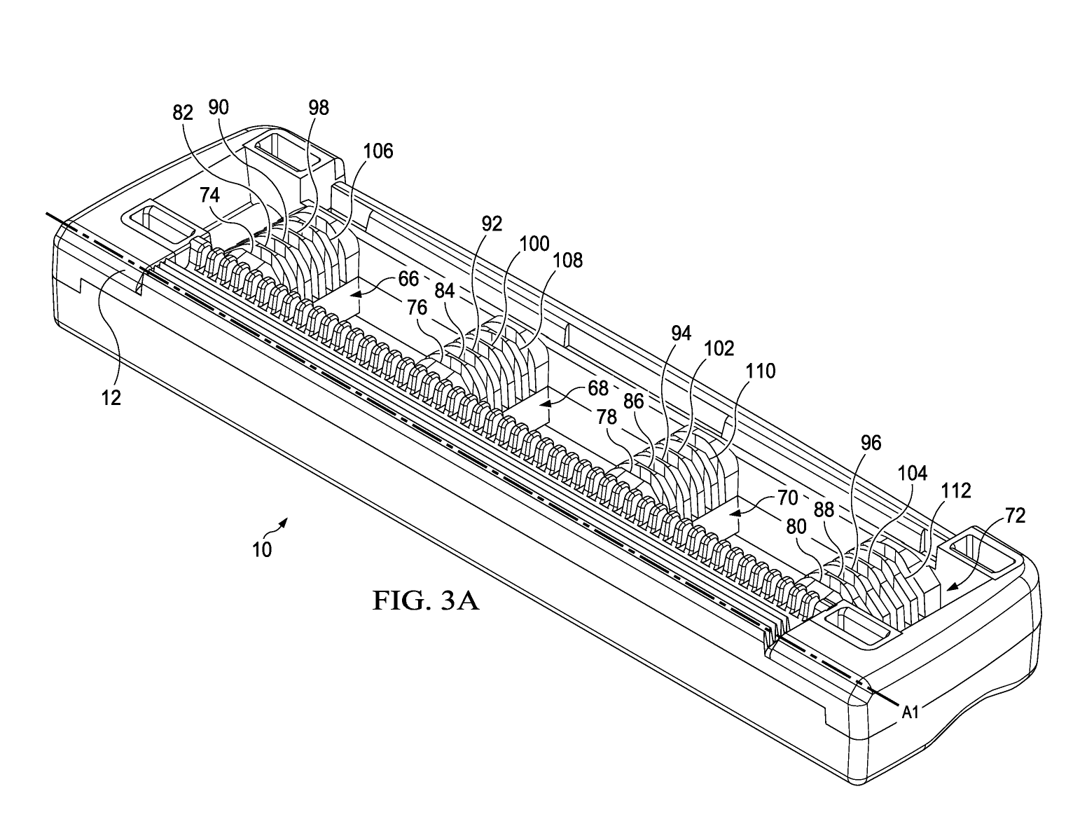

Referring to FIG. 3, an assembly view of the shaving razor cartridge 10 is shown. In certain embodiments, the blades 22, 24, 26, 28 and 30 may be mounted to the housing 12 and secured by one or more clips 62 and 64 located at opposite lateral sides of the housing 12. The blades 22, 24, 26, 28 and 30 may be fixed in the housing 12 or may be resiliently mounted such that the blades 22, 24, 26, 28 and 30 are biased against the clips 62 and 64. The clips 62 and 64 may aid in retaining the blades 22, 24, 26, 28 and 30 in an up and down direction (i.e., toward and away from a top surface 55 of the housing 12). Each of the clips 62 and 64 may extend completely thru the housing 12. The clips 62 and 64 may comprise a metal, such as aluminum or plastic. The clips 62 and 64 may also be interconnected to form a one piece assembly. Other assembly methods known to those skilled in the art may also be used to secure and/or mount the blades 22, 24, 26, 28 and 30 to the housing 12 including, but not limited to, wire wrapping, cold forming, hot staking, insert molding, ultrasonic welding, and adhesives.

In certain embodiments, it may be important to retain the blades 22, 24, 26, 28 and 30 in a shaving direction for improved efficiency and comfort. As shown in FIG. 2, shaving forces Fl may exert a force on the blades 22, 24, 26, 28 and 30 in a direction from the guard 14 toward the cap 18. Accordingly, one or more blade support members 66, 68, 70 and 72 (as shown in FIG. 3) may be provided to resist rearward movement of the blades 22, 24, 26, 28 and 30. The blade support members 66, 68, 70 and 72 may be spaced apart for improved rinsing of the shaving razor cartridge 10. In certain embodiments, the blade support members 66, 68, 70 and 72 may be positioned between the clips 62 and 64 (e.g., laterally inboard) and between the guard 14 and the cap 18. Although four blade support members 66, 68, 70 and 72 are shown, more or less blade support members may be used depending on the desired level of blade rigidity and rinsing desired. For example, more blade support members 66, 68, 70 and 72 may improve blade rigidity, but additional blade support members tend to decrease rinsibility.

Referring to FIG. 3A, a perspective view of the housing 12 of the shaving razor cartridge 10 in FIG. 3 is illustrated. Each of the blade support members 66, 68, 70 and 72 of the housing 12 may define at least one slot dimensioned to receive one of the respective blades. For example, the blade support members 66, 68, 70 and 72 may each define a first blade slot 74, 76, 78 and 80 to receive the primary blade 22. The first slots 74, 76, 78, and 80 may be generally aligned with each other and parallel to a longitudinal axis A1 of the housing 12 to allow for assembly of the primary blade 22 (as shown in FIG. 3) to the housing 12 Similarly, the blade support members 66, 68, 70 and 72 may each define a second slot 82, 84, 86 and 88. The second slots 82, 84, 86 and 88 may also be generally aligned with each other and parallel to the longitudinal axis A1 of the housing 12 to receive the secondary blade 24 (e.g., a base portion 44 of the secondary blade 24, as shown in FIG. 3). Accordingly, the blade support members 66, 68, 70 and 72 may have additional slots to receive the other blades 26, 28 and 30 (as shown in FIG. 3) in a similar fashion. For example, the blade support members 66, 68, 70 and 72 may each define a third blade slot 90, 92, 94 and 96 to receive the third blade 26 (e.g., a base portion 46 of the third blade 26, as shown in FIG. 3). The blade support members 66, 68, 70 and 72 may each define a fourth blade slot 98, 100, 102 and 104 to receive the fourth blade 28 (e.g., a base portion 48 of the fourth blade 28, as shown in FIG. 3). Lastly, the blade support members 66, 68, 70 and 72 may each define a fifth blade slot 106, 108, 110 and 112 to receive the fifth blade 30 (e.g., the base portion 50 of the fifth blade 30, as shown in FIG. 3).

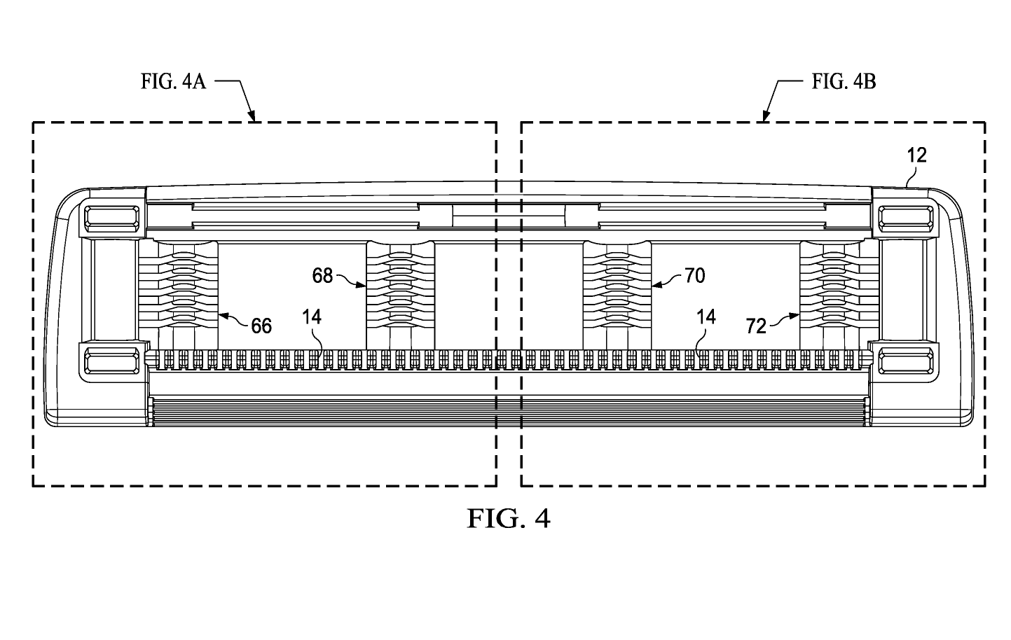

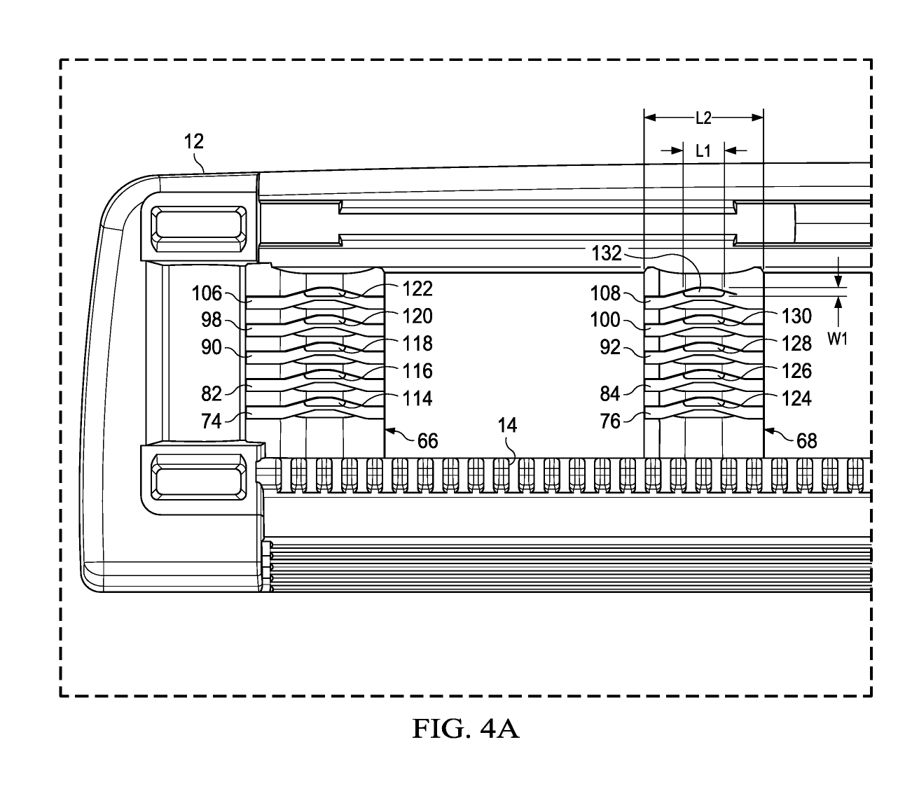

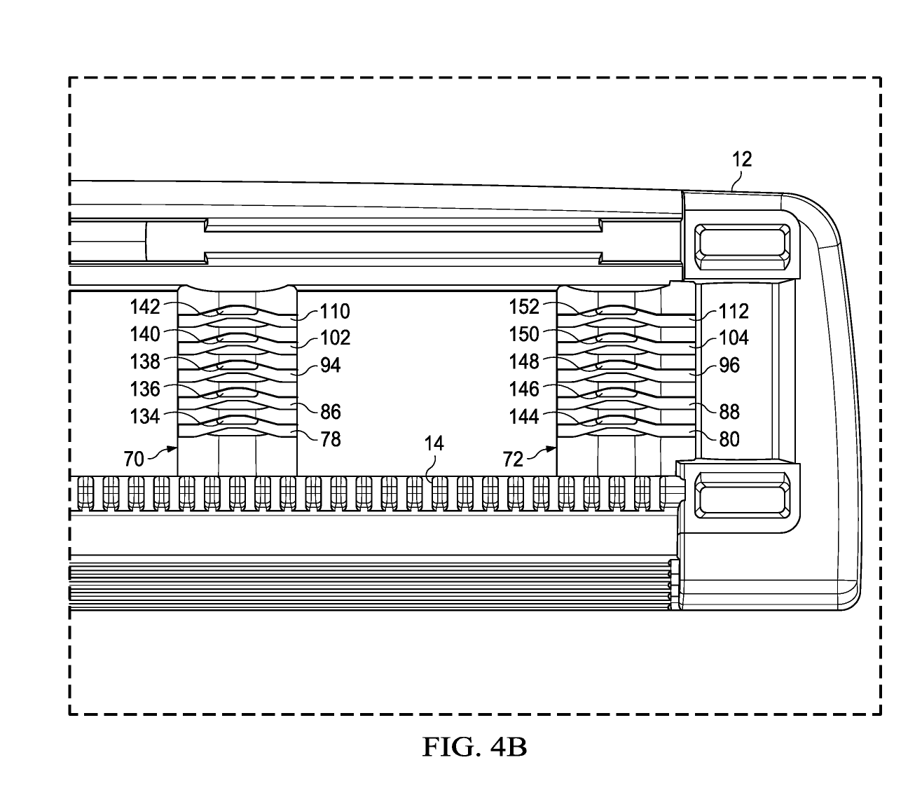

Referring to FIGS. 4, 4A and 4B several top views of the housing 12 are shown. FIG. 4 is a top view of the entire housing 12. FIG. 4A is an enlarged view of the left hand side of the housing 12 and FIG. 4B is a right hand view of the housing 12. The blade support members 66, 68, 70 and 72 may be spaced apart and parallel to each other (e.g., transverse to the guard 14) to define open spaces there between. The spacing of the blade support members 66, 68, 70 and 72 may allow for water to rinse the blades (not shown) and help prevent clogging. In certain embodiments, the blade support members 66, 68, 70 and 72 may define one or more rinse openings 114, 116, 118, 120, 122, 124, 126, 128, 130 and 132 (as shown in FIG. 4A) and 134, 136, 138, 140, 142, 144, 146, 148, 150 and 152 (as shown in FIG. 4 extending completely thru the housing 12. The rinse openings 114, 116, 118, 120, 122, 124, 126, 128, 130, 132, 134, 136, 138, 140, 142, 144, 146, 148, 150 and 152 may extend thru a bottom surface of the housing 12 such that they are not obstructed by the housing 12 or other features, such as the clips 62 and 64 (not shown). For example, the clips 62 and 64 (as shown in FIG. 3) may be outboard (e.g., laterally) of the blade support members 66, 68, 70 and 72 and thus the rinse openings 114, 116, 118, 120, 122, 124, 126, 128, 130, 132, 134, 136, 138, 140, 142, 144, 146, 148, 150 and 152 as well. As shown in FIG. 4A, first blade support member 66 may define the plurality of rinse openings 114, 116, 118, 120 and 122 that are in communication with corresponding blade slots 74, 82, 90, 98, 106. For example, rinse opening 114 may be in communication with the first blade slot 74. The blade slots 74, 82, 90, 98, 106 may extend generally parallel to the guard 14 to receive the respective blades 22, 24, 26, 28 and 30 (not shown). It is understood that the other blade support members 68, 70 and 72 may have similar rinse openings in communication with respective blade slots. As shown in FIG. 4A, the second blade support member 68 may have rinse openings 124, 126, 128, 130 and 132 that are in communication with respective blade slots 76, 84, 92, 100 and 108. As shown in FIG. 4B, the third blade support member 70 may have rinse openings 134, 136, 138, 140 and 142 that are in communication with respective blade slots 78, 86, 94, 102 and 110. The fourth blade support member 72 may have rinse openings 144, 146, 148, 150 and 152 that are in communication with respective blade slots 80, 88, 96, 104 and 112.

The rinse openings may be dimensioned to provide maximum rinsing while still providing sufficient rigidity to support the blades. For example, the rinse opening 132 may have a length L1 (i.e., in a direction parallel to the guard 14 and or blade 22) of about 0.5 mm to about 2 mm. The blade support member 68 may have a length L2 (parallel to the guard and or blade 22) of about 2.0 mm to about 5.0 mm. The rinse openings may be elongated (e.g., also have a minimum width w1 that is less than the length L1). In certain embodiments, the minimum width w1 may be about 0.1 mm to about 0.325 mm. The other rinse openings may be similarly dimensioned.

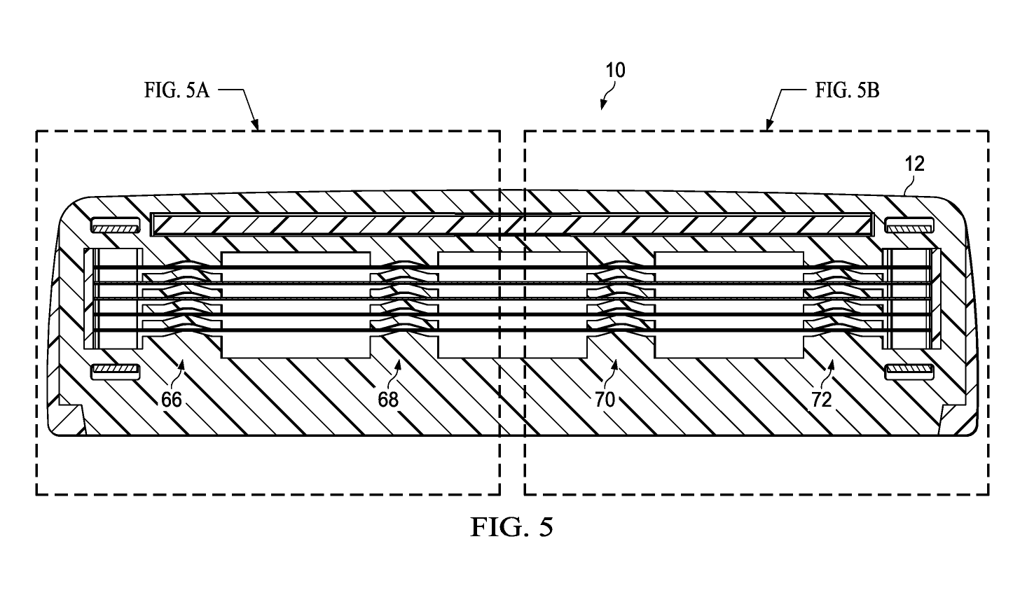

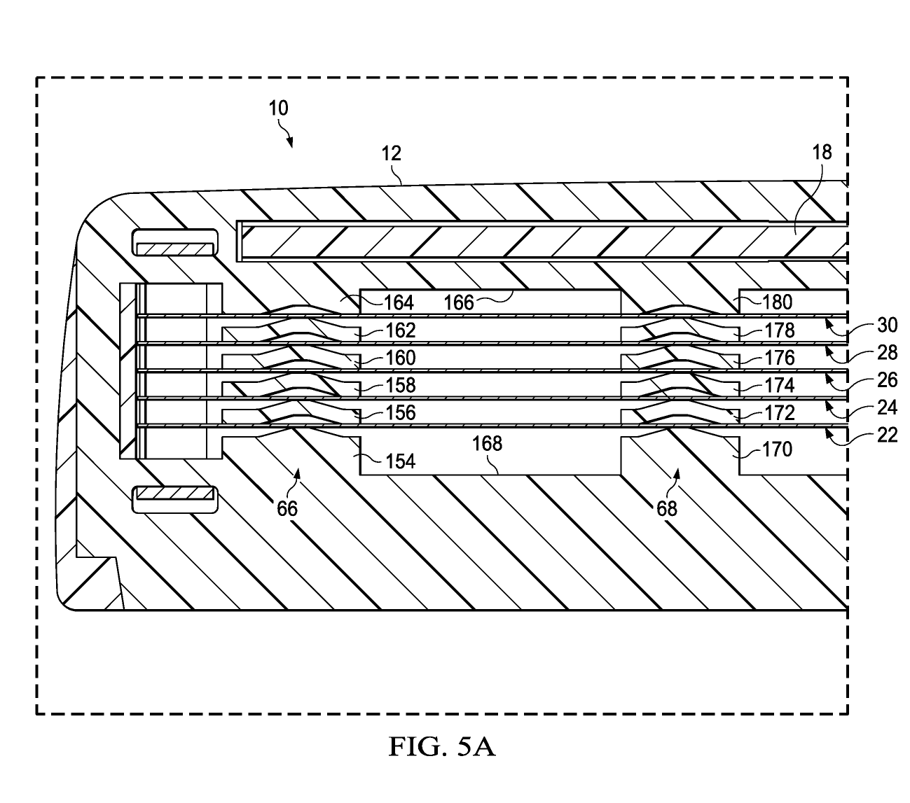

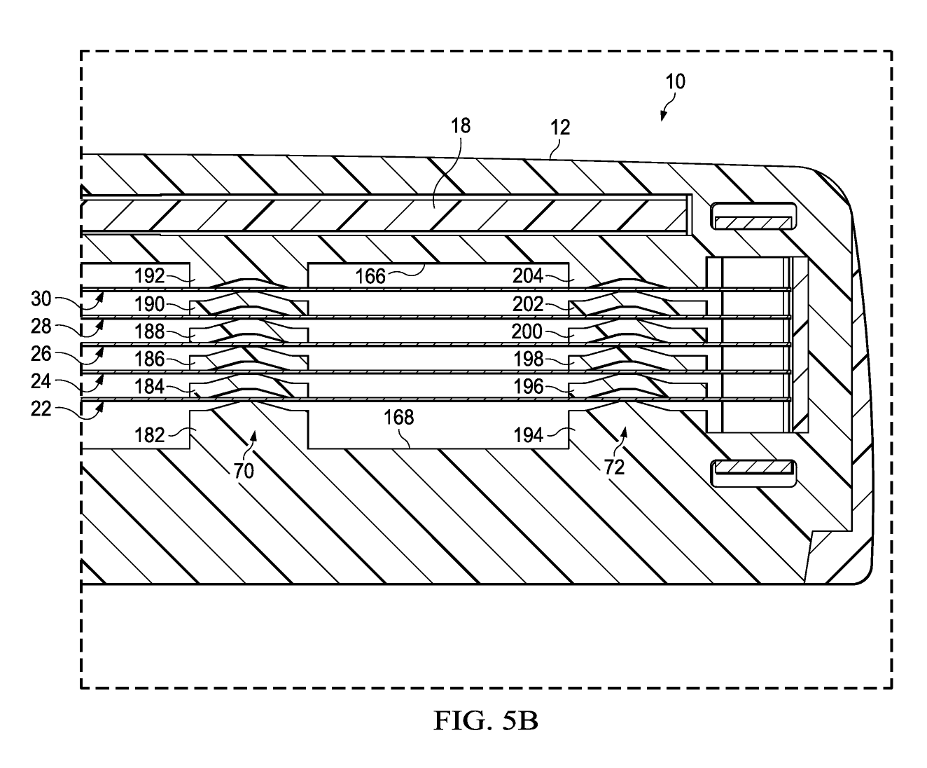

Referring to FIGS. 5, 5A and 5B section views of the shaving razor cartridge 10 are illustrated, taken generally along the line 5-5 of FIG. 1. FIG. 5A is an enlarged left hand side view of FIG. 5 and FIG. 5B is an enlarged right hand side view of FIG. 5. In certain embodiments, each of the blade support members 66, 68, 70 and 72 may have a plurality of blade retention members that extend upwardly in a transverse direction from the corresponding blade support member 66, 68, 70 and 72. As shown in FIG. 5A, the first blade support 66 member may have a first blade retention member 154 nearest the guard 14 (not shown), a second blade retention member 156 behind the first blade retention member 154, a third blade retention member 158 behind the second blade retention member, a fourth blade retention member 160 behind the third blade retention member 158, a fifth blade retention member 162 behind the fourth blade retention member 160, and a sixth blade retention member 164 behind the fifth blade retention member 162 and closest to the cap 18. The blade retention members 154, 156, 158, 160, 162 and 164 may be generally aligned with each other along the blade support member 66. In certain embodiments, the sixth blade retention member 164 may project from an inner wall 166 (e.g., toward the guard 12) of the housing 12 and the first blade retention member 154 may project from an opposing inner wall 168 of the housing 12 (e.g., toward the cap 18) for increased rigidity.

The second blade support member 68 may have a first blade retention member 170 nearest the guard 14, a second blade retention member 172 behind the first blade retention member 170, a third blade retention member 174 behind the second blade retention member 172, a fourth blade retention member 176 behind the third blade retention member 174, a fifth blade retention member 178 behind the fourth blade retention member 176 and a sixth blade retention member 180 nearest the cap 18 and behind the fifth blade retention member 178. In certain embodiments, the sixth blade retention member 180 may project from the inner wall 166 of the housing 12 and the first blade retention member 164 may project from the opposing inner wall 168 of the housing 12 for increased rigidity.

As shown in FIG. 5B, the third blade support member 70 may have a first blade retention member 182 nearest the guard 14, a second blade retention member 184 behind the first blade retention member 182, a third blade retention member 186 behind the second blade retention member 184, a fourth blade retention member 188 behind the third blade retention member 186, a fifth blade retention member 190 behind the fourth blade retention member 188, a sixth blade retention member 192 behind the fifth blade retention member 190 and nearest the cap 18. In certain embodiments, the sixth blade retention member 192 may project from the inner wall 166 of the housing 12 and the first blade retention member 182 may project from the opposing inner wall 168 of the housing 12 for increased rigidity.

The fourth blade support member 72 may have a first blade retention member 194 nearest the guard 14, a second blade retention member 196 behind the first blade retention member 194, a third blade retention member 198 behind the second blade retention member 196, a fourth blade retention member 200 behind the third blade retention member 198, a fifth blade retention member 202 behind the fourth blade retention member 200 and a sixth blade retention member 204 behind the fifth blade retention member 202 and nearest the cap 18. Referring to FIGS. 5A and 5B, the primary blade 22 may be retained between the first blade retention members 154, 170, 182 and 194 and the second blade retention members 156, 172, 184 and 196. The first blade retention members 154, 170, 182 and 194 and the second blade retention members 156, 172, 184 and 196 may define the respective blade slots 74, 76, 78 and 80 previously described and illustrated in FIGS. 4A and 4B. The secondary blade 24 may be retained between the second blade retention members 156, 172, 184 and 196 and the third blade retention members 158, 174, 186 and 198. The third blade 26 may be retained between the third blade retention members 158, 174, 186 and 198 and the fourth blade retention members 160, 176, 188 and 200. The fourth blade 28 may be retained between the fourth blade retention members 160, 176, 188 and 200 and the fifth blade retention members 162, 178, 190 and 202. The fifth blade 30 blade may be retained between the fifth blade retention members 162, 178, 190 and 202 and the sixth blade retention members 164, 180, 192, and 204.

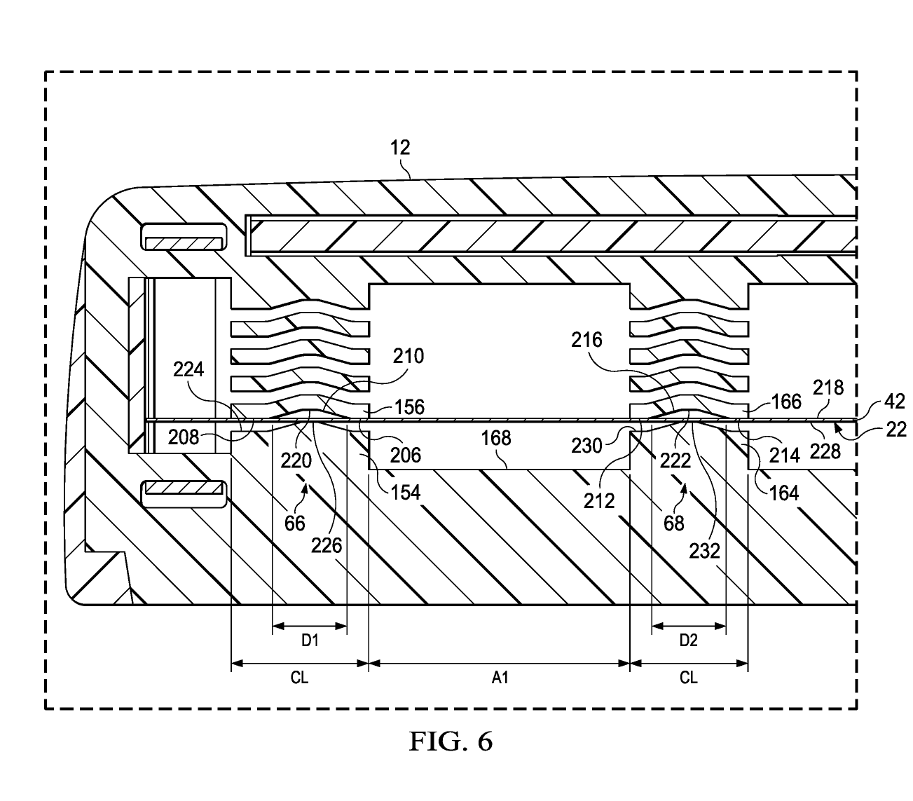

The blade retention members may have a wave shape structure to facilitate rinsing and retaining the blades 22, 24, 26, 28 and 30 (e.g., to prevent rearward rocking of the blades 22, 24, 26, 28 and 30 during a shaving stroke). It is understood that all of the blade retention members may have a similar structure and function. Accordingly, only a limited number of the blade retention members will be described in detail. Referring to FIG. 6, the housing 12 may provide a first pair of spaced apart blade contact surfaces 206 and 208 on a common wall 210 (i.e., a front wall of the blade retention member 156) that are spaced apart from a second pair of spaced apart blade contact surfaces 212 and 214 on another common wall 216 (i.e., a front wall of the blade retention member 166). The first pair of spaced apart blade contact surfaces 206 and 208 may extend in an upward direction from the first blade support member 66 and the second pair of spaced apart blade contact surfaces 212 and 214 may extend from the second blade support member 68. The base portion 42 of the primary blade 22 may have a rear wall 218. The rear wall 218 of the primary blade 22 may contact both pairs of spaced apart blade contact surfaces 206, 208, 212 and 214 during a shaving stroke. The common walls 210 and 216 may comprise plastic or metal, depending on the desired stiffness to support the blades 22 (blades 24, 26, 28 and 30 not shown).

The first pair of spaced apart blade contact surfaces 206 and 208 may be spaced apart by a first distance “D1” that is less than a distance “A1” between the pair of common walls 210 and 216. Similarly, the second pair of spaced apart blade contact surfaces 212 and 214 may be spaced apart by a second distance “D2” that is less than the distance A1 between the pair of common walls 210 and 216. In certain embodiments, the first distance D1 and the second distance D2 may be about 1.0 mm to about 3.5 mm and the distance A1 between the common walls 210 and 216 may be about 4.0 mm to about 10.0 mm. The first distance D1 and the second distance D2 may be equal (e.g., within typical manufacturing tolerances) or similar (e.g., within 10% of each other). The first distance D1 (and/or second distance D2) may be about 20% to about 40% of the distance A1 between the pair of common walls 210 and 216 to provide sufficient blade retention and minimize rocking of the primary blade 22, while still allowing for sufficient open space for rinsing the blades. The first distance and the distance between the pair of common walls 210 and 216 may vary depending on a thickness of the base of the primary blade 22. For example, a thinner blade may require more support than a thicker blade. In certain embodiments, the thickness of the base of the blades (e.g., primary blade 22) may be about 0.07 mm to 0.160 mm. The other blades may have a similar thickness for the base.

In certain embodiments, the housing 12 may have a support ratio less than 4.0 (e.g., about 2.5 to about 3.0). The support ratio may be equal to the distance A1 between the pair of common walls 210 and 216 divided by the support height “SH1” (as shown in FIG. 2). If the distance A1 is too large, deflection of the blade increases as forces are applied to the blades during a shaving stroke. If the support height “SH1” is too small, the blades and or the cutting edges of the blades may rock or bend in a rearward direction.

The common walls 210 and 216 may be a variety of different shapes and sizes in order to provide spaced apart blade contact surfaces having the proper spacing. For example, as shown in

FIG. 6, the common walls 210 and 216 may have a wave-like shape. The common walls 210 and 216 may each have a respective 220 and 222 trough (e.g., a concave surface facing toward the guard) in-between the pair of spaced apart blade contact surfaces. Accordingly, the primary blade may not contact the troughs 220 and 222, but only the pair of spaced apart blade contact surfaces 206, 208, 212 and 214. The troughs 220 and 222 may allow for sufficient spacing for the rinse thru openings 114, 116, 118, 120, 122, 124, 126, 128, 130, 132 (as shown in FIG. 4A).

The housing 12 may also have a wall 224 spaced apart from and in front of the common wall 210 of the first pair of spaced apart blade contact surfaces 206 and 208 (e.g., the wall 224 is positioned toward the guard 14). For example, the wall 224 may be a rear wall of the first blade retention member 154. The wall 224 in front of the common wall 210 may have a single blade contact surface 226 positioned between the first pair of spaced apart blade contact surfaces 212 and 214 and faces a front wall 228 of the base 42 of the primary blade 22. The blade contact surface 226 may be generally aligned with the trough 220 (i.e., the area of the common wall 216 that does not contact the primary blade). Similarly, the housing 12 may also have a wall 230 spaced apart from and in front of the common wall 216 of the second pair of spaced apart blade contact surfaces 212 and 214 (e.g., toward the guard 14). For example, the wall 230 may be a rear wall of the first blade retention member 164. The wall 230 in front of the common wall 216 may have a single blade contact surface 232 positioned between the second pair of spaced apart blade contact surfaces 212 and 214 and faces the front wall 228 of the base 42 of the primary blade 22. The blade contact surface 232 may be generally aligned with the trough 222 (i.e., the area of the common wall 216 that does not contact the primary blade 22).

The primary blade 22 may be assembled between the first pair of spaced apart blade contact surfaces 206 and 208 and the blade contact surface 226 to create three closely spaced areas of contact with the primary blade 22 (two at the rear face 218 of the primary blade 22 and one at the front face 228 of the primary blade). Similarly, primary blade 22 may also be assembled between the second pair of spaced apart blade contact surfaces 212 and 214 and the blade contact surface 232 to create three closely spaced areas of contact with the primary blade 22 (two at the rear face 218 of the primary blade 22 and one at the front face 228 of the primary blade). It is understood that additional blade contact surfaces may be provided as those described above for the first and second blade retention members 154, 156, 164 and 166. In certain embodiments, these three contact areas may be within a contact length “CL” of about 2.0 mm to about 5.0 mm. The contact length “CL” may be the length of the respective common wall 210 and/or the wall 224. Accordingly, a length of the common wall 210 that contacts the base of the blade may be the difference between CL and D1. A length of the common wall 216 that contact the base of the blade may be the difference between CL and D2. During shaving, the primary blade 22 may contact the first pair of spaced apart blade contact surfaces 206 and 208 and the second pair of spaced apart blade contact surfaces 212 and 214 to minimize blade movement, which may lead to discomfort and an inefficient shave. In addition, the blade contact surfaces 226 and 232 may be spaced apart from the primary blade during a shaving stroke because the shaving forces move the blades in a rearward direction toward the cap 18.

It is understood the blade retention members 158, 160, 162 and 164 of the first blade retention member 66 may be similarly shaped to hold the other blades 24, 26, 28 and 30. It is also understood that the other blade support members 68, 70 and 72 also have similarly shaped blade retention members to provide sufficient support to retain the other blades 24, 26, 28 and 30 during a shaving stroke. The rigidity of the blade retention members may be increased by having pairs of spaced apart blade contact surfaces that are interconnected (i.e., on the common wall) instead of being spaced apart from each other. The increased rigidity of the blade retention members may allow for easier molding of the housing, easier assembly of the blades and decreased movement of blades during a shaving stroke.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor cartridge comprising:
a housing having a guard at a front portion of the housing, a cap at a rear portion of the housing, a first blade support member positioned between the guard and the cap, the first blade support member having a first blade retention member spaced apart from a second blade retention member to define a first blade slot, the first blade support defines at least one rinse opening in communication with the first blade slot and extending completely through the housing.

2. The shaving razor cartridge of claim 1 further comprising a primary blade having a cutting edge that extends toward the guard and a base portion that is mounted between the first blade retention member and in front of the rinse opening.

3. The shaving razor cartridge of claim 2 wherein the primary blade is a unitary member having a bent portion between the base portion and the cutting edge.

4. The shaving razor cartridge of claim 1 wherein the housing comprises a plurality of spaced apart blade support members positioned between the guard and the cap.

5. The shaving razor cartridge of claim 4 wherein the blade support members are parallel to each other and transverse to the guard and or the cap.

6. The shaving razor cartridge claim 5 wherein each of the blade support members define at least one rinse openings.

7. The shaving razor cartridge of claim 6 further comprising a primary blade having a cutting edge that extends toward the guard and a base portion that is mounted between the first blade retention member and in front of each of the rinse openings.

8. The shaving razor cartridge of claim 1 wherein the rinse opening has a length that is about 10% to about 50% of a length of the blade support member.

9. The shaving razor cartridge of claim 1 wherein the rinse opening has a width that is less than a length of the rinse opening.

10. The shaving razor cartridge of claim 1 further comprising a plurality of blades mounted to the housing and secured with a clip.

11. The shaving razor cartridge of claim 10 wherein the guard is segmented.

12. The shaving razor cartridge of claim 1 wherein the first blade retention member has a rear wall with a crest projecting toward the cap and extending between a pair of lateral end portions of the rear wall, the second blade retention member having a front wall facing the rear wall, the front wall having a trough extending between a pair of lateral end portions of the front wall.

13. The shaving razor cartridge of claim 12 wherein the rinse opening is positioned between the lateral ends of the front wall.

14. The shaving razor cartridge of claim 12 wherein the rinse opening is positioned between the crest of the rear wall and the trough of the front wall.

15. The shaving razor cartridge of claim 12 further comprising a primary blade having a base portion mounted in the first blade slot.
